(19) United States
(12) Patent Application Publication
(10) Pub. No.: US 2025/0322559 A1
(43) Pub. Date: Oct. 16, 2025

(54) METHOD AND SYSTEM FOR AUTOMATICALLY GENERATING DESIGN DELIVERABLES

(71) Applicant: SAMSUNG SDS CO., LTD., Seoul (KR)

(72) Inventors: In Hye JUNG, Seoul (KR); Hye Jin BAE, Seoul (KR); Ji Hye LEE, Seoul (KR); Sung Won CHO, Seoul (KR); JI SEON CHOI, Seoul (KR)

(73) Assignee: SAMSUNG SDS CO., LTD., Seoul (KR)

(21) Appl. No.: 19/062,825

(22) Filed: Feb. 25, 2025

(30) Foreign Application Priority Data
Apr. 11, 2024 (KR) 10-2024-0048415
May 23, 2024 (KR) 10-2024-0067218

(51) Int. Cl. G06T 11/00; G06F 40/30

(52) U.S. Cl. CPC G06T 11/00; G06F 40/30

(57) ABSTRACT

A method and system for automatically generating design deliverables are provided. According to the aforementioned and other embodiments of the present disclosure, a method for automatically generating design deliverables performed by a computing system is provided. The method may comprise receiving a first prompt from a user terminal and transmitting the first prompt to a generative artificial intelligence (AI) system, transmitting at least some of a plurality of images associated with the first prompt to the user terminal, receiving a user's selection input for at least one of the plurality of images associated with the first prompt from the user terminal and transmitting a first image corresponding to the user's selection input to the generative AI system and receiving a second image generated by the generative AI system based on the first image and the first prompt.

### CROSS-REFERENCE TO RELATED APPLICATIONS

This application claims priority from Korean Patent Application Nos. 10-2024-0048415 filed on Apr. 11, 2024 and 10-2024-0067218 filed on May 23, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for automatically generating design deliverables and a system to which the method is applied, and more specifically, to a method for generating design deliverables using generative artificial intelligence (AI) to enhance a user's intent for generating design deliverables through interactions between the generative AI and the user, and a system to which the method is applied.

### 2. Description of the Related Art

In the field of design, a conventional method is used where a non-expert user obtains design deliverables by entering prompts related to the characteristics of desired design deliverables into generative artificial intelligence (AI).

However, in the conventional method of using generative AI, the design deliverables obtained by the user often differ from the user's original intent. In such cases, the user must modify the initial prompt entered into the generative AI, input a new prompt, and wait for new deliverables to be generated.

That is, in order for the user to obtain the desired design deliverables, the process of re-entering prompts and waiting for output generation is repeated, resulting in a significant waste of time.

For example, referring to FIG. 1, when the user inputs a prompt containing a keyword 11, “little scientist,” into the generative AI, the generative AI may provide the user with an image 12 containing a Western-looking object and an image 13 containing an Eastern-looking object. However, if the shape of the “little scientist” desired by the user differs from both images, the user will need to modify the prompt, re-enter it into the generative AI, and wait for a considerable amount of time for new images to be generated.

This issue can be resolved if the user initially inputs a prompt containing a detailed description of the shape of the desired “little scientist.” However, it is difficult for a non-expert user in the field of design to compose detailed prompts without knowing the visual results of deliverables.

Meanwhile, the generative AI receives prompts from the user and provides image-format files to the user. Since the provided files are in a completed image format, there is a conventional issue where detailed modifications to the images are not easily possible.

Therefore, there has been a demand for a method that enables the user to clearly input their design intent into the generative AI through a visual interaction method between the generative AI and the user, and for a method to modify the design deliverables provided by the generative AI. However, such methods have not been available due to the technical difficulty of implementation.

### SUMMARY

An objective of the present disclosure is to provide a visual interaction method between a user and generative artificial intelligence (AI).

Another objective of the present disclosure is to provide a method that allows the user to input a prompt into the generative AI in image format.

Another objective of the present disclosure is to provide a method for automatically reviewing the design deliverables generated by the generative AI.

Another objective of the present disclosure is to provide an interface enabling the user to modify the design deliverables generated by the generative AI.

Another objective of the present disclosure is to provide a method that suggests modifications to ambiguous phrases included in the prompt currently being input by the user.

The objectives of the present disclosure are not limited to those mentioned above, and other objectives not explicitly stated will be clearly understood by those skilled in the art based on the following description.

According to some embodiments of the present disclosure, a design deliverable generation system is provided. The system may comprise: at least one processor, an internal storage configured to store at least one image and a memory configured to store a computer program executed by the at least one processor. The computer program may include instructions for performing operations of: receiving a first prompt from a user terminal and transmitting the first prompt to a generative artificial intelligence (AI) system, transmitting at least some of a plurality of images associated with the first prompt to the user terminal, receiving a user's selection input for at least one of the plurality of images associated with the first prompt from the user terminal and transmitting a first image corresponding to the user's selection input to the generative AI system and receiving a second image generated by the generative AI system based on the first image and the first prompt.

In some embodiments, the plurality of images associated with the first prompt may include images generated by the generative AI system based on the first prompt, images pre-stored in an external storage associated with the first prompt, or images pre-stored in the internal storage associated with the first prompt.

In some embodiments, the computer program may further include instructions for performing the operation of transmitting the second image to the user terminal, and the operation of transmitting the second image to the user terminal may comprise transmitting the second image and a description associated with the second image to the user terminal.

In some embodiments, the computer program may further include instructions for performing the operation of determining whether the second image complies with a deliverable review guide, and the operation of determining whether the second image complies with the deliverable review guide may comprises determining whether the second image complies with security guidelines and determining whether the second image complies with design guidelines.

In some embodiments, the operation of determining whether the second image complies with the security guidelines may comprises determining whether the second image includes a component having a similarity exceeding a threshold with a component included in data of the security guidelines and determining whether a visual component of the second image includes an element that infringes on copyrights.

In some embodiments, wherein the operation of determining whether the second image complies with the design guidelines may comprise determining whether a text component of the second image complies with predefined specifications of the design guidelines.

In some embodiments, the computer program may further include instructions for performing the operation of determining whether when modified, a first property of a first component included in the second image complies with the deliverable review guide.

In some embodiments, the computer program may further include instructions for performing the operation of providing a code editing interface corresponding to properties of each component included in the second image to the user terminal.

According to the aforementioned and other embodiments of the present disclosure, a design deliverable generation system is provided. The system may comprise: at least one processor, an internal storage configured to store at least one image and a memory configured to store a computer program executed by the at least one processor. The computer program may comprise instructions for performing operations of: receiving a second prompt from a user terminal, evaluating a specificity of a first phrase included in the second prompt, transmitting a list of sub-concept data included in the first phrase to the user terminal if the specificity of the first phrase falls below a threshold, receiving a user's selection input for first sub-concept data from the list of sub-concept data from the user terminal, and transmitting a third prompt obtained by modifying the second prompt using the first sub-concept data, and transmitting the third prompt to the user terminal.

In some embodiments, the operation of evaluating the specificity of the first phrase included in the second prompt may comprise performing semantic analysis on the second prompt and determining that the specificity of the first phrase falls below the threshold if the semantic analysis indicates that a plurality of pieces of data corresponding to the first phrase exist.

In some embodiments, the sub-concept data included in the first phrase may include a first image corresponding to the first phrase, and a second phrase corresponding to the first phrase.

In some embodiments, the computer program may further comprise instructions for performing operations of: transmitting the third prompt to a generative artificial intelligence (AI) system, transmitting at least some of a plurality of images associated with the third prompt to the user terminal, receiving the user's selection input for at least one of the plurality of images associated with the third prompt from the user terminal and transmitting a third image corresponding to the user's selection input to the generative AI system, and receiving a fourth image associated with the third image and the third prompt from the generative AI system.

In some embodiments, the computer program may further comprise instructions for performing the operation of: providing a code editing interface corresponding to properties of each component included in the fourth image to the user terminal.

According to the aforementioned and other embodiments of the present disclosure, a method for automatically generating design deliverables performed by a computing system is provided. The method may comprise receiving a first prompt from a user terminal and transmitting the first prompt to a generative artificial intelligence (AI) system, transmitting at least some of a plurality of images associated with the first prompt to the user terminal, receiving a user's selection input for at least one of the plurality of images associated with the first prompt from the user terminal and transmitting a first image corresponding to the user's selection input to the generative AI system and receiving a second image generated by the generative AI system based on the first image and the first prompt.

In some embodiments, the plurality of images associated with the first prompt may include images generated by the generative AI system based on the first prompt, images pre-stored in an external storage associated with the first prompt, or images pre-stored in an internal storage of the computing system associated with the first prompt.

In some embodiments, the method may further comprise transmitting the second image to the user terminal. The transmitting the second image may comprise transmitting the second image and a description associated with the second image to the user terminal.

In some embodiments, The method may further comprise determining whether the second image complies with a deliverable review guide. The determining whether the second image complies with the deliverable review guide may comprise determining whether the second image complies with security guidelines and determining whether the second image complies with design guidelines.

In some embodiments, the determining whether the second image complies with the security guidelines may comprise determining whether the second image includes a component having a similarity exceeding a threshold with a component included in the security guidelines and determining whether a visual component of the second image includes an element that infringes on copyrights.

In some embodiments, the determining whether the second image complies with the design guidelines may comprise determining whether a text component of the second image complies with predefined specifications of the design guidelines.

In some embodiments, The method may further comprise receiving a second prompt from the user terminal and displaying the second prompt on a screen of the user terminal, evaluating a specificity of a first phrase included in the second prompt, transmitting a list of sub-concept data included in the first phrase to the user terminal if the specificity of the first phrase falls below a threshold, receiving a user's selection input for first sub-concept data from the list of sub-concept data from the user terminal and generating a third prompt by modifying the second prompt using the first sub-concept data and transmitting the third prompt to the user terminal.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram for explaining problems in the related art of the relevant technical field;

FIG. 2 is a diagram illustrating an environment to which a design deliverable generation system according to an embodiment of the present disclosure can be applied;

FIG. 3 is a flowchart illustrating a method for automatically generating design deliverables according to an embodiment of the present disclosure;

FIG. 4 is a diagram for explaining the step of displaying a plurality of images associated with a first prompt on a screen, which can be performed in some embodiments of the present disclosure;

FIG. 5 is a diagram for explaining the step of transmitting a first image corresponding to a user's selection input to a generative AI system, which can be performed in some embodiments of the present disclosure;

FIG. 6 is a diagram for explaining the step of displaying a second image and a description related to the second image on a screen, which can be performed in some embodiments of the present disclosure;

FIG. 7 is a flowchart illustrating some steps explained with reference to FIG. 3;

FIG. 8 is a diagram for explaining the step of providing a code editing interface for properties of components in a second image, which can be performed in some embodiments of the present disclosure;

FIG. 9 is a diagram illustrating a code editing interface explained with reference to FIG. 8;

FIG. 10 is a diagram for explaining the step of displaying deliverable review violations, which can be performed in some embodiments of the present disclosure;

FIG. 11 is a flowchart illustrating a method for automatically generating design deliverables according to another embodiment of the present disclosure;

FIG. 12 is a diagram for explaining the step of generating a third prompt by modifying a second prompt, which can be performed in some embodiments of the present disclosure;

FIG. 13 is a diagram for explaining the step of displaying a list of sub-concept data included in a first phrase on a screen, which can be performed in some embodiments of the present disclosure; and

FIG. 14 is a hardware configuration diagram of a computing system according to another embodiment of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Before explaining various embodiments of the present disclosure, the terms used in the following embodiments will be clarified.

In the following embodiments, “generative AI” refers to artificial intelligence (AI) that can generate content such as text, images, and videos corresponding to an input prompt. For example, the generative AI may include, but is not limited to, Gemini, GPT, DALL-E, and NovelAI as long as it can generate content corresponding to the given prompt.

In the following embodiments, “deliverable review guide” refers to a predefined ruleset used to review specific deliverables. The deliverable review guide may include “design guidelines” and “security guidelines,” which will be described later.

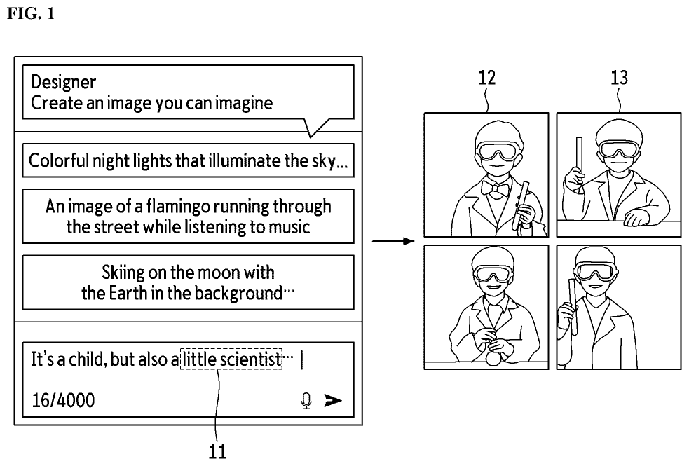

In the following embodiments, “component” refers to each object included in a specific image or design deliverable. For example, in the image 12 of FIG. 1 that contains a Western-looking object, the goggles, flask, person, and image background may be considered distinct components.

In the following embodiments, the “property of a component” refers to attributes of each component included in a specific image or design deliverable, such as color, shape, text string, text font, or size. However, it is not limited to these attributes and encompasses other attributes as long as they can be expressed as values.

Additionally, the “property of an image” refers to attributes of a specific image such as size, exposure, depth of field, and applied filters. However, it is not limited to these attributes and encompasses other attributes as long as they can be expressed as values.

In the following embodiments, “visual interaction” refers to an act in which a user selects and inputs one or more images or videos displayed on the screen of a user terminal and sends the selected and input images or videos to a generative AI system to specify the characteristics of the design deliverable the user intends to create.

Some embodiments of the present disclosure will hereinafter be described with reference to the accompanying drawings.

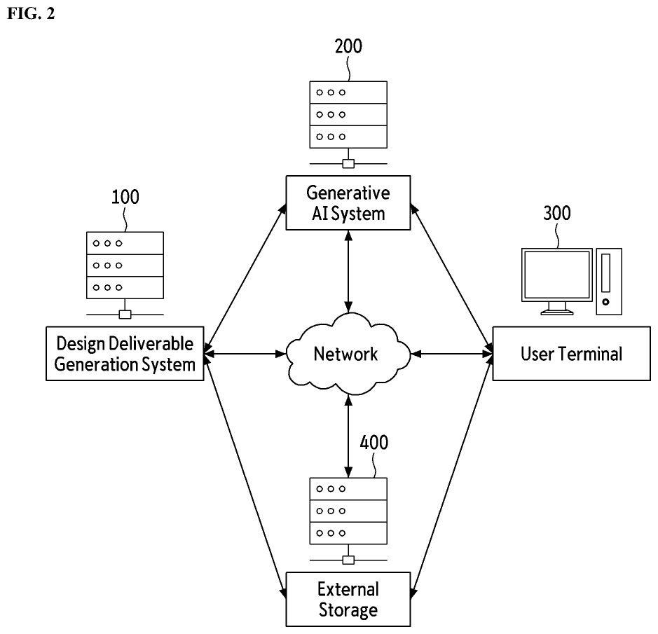

FIG. 2 illustrates an environment in which a design deliverable generation system 100 according to one embodiment of the present disclosure may be applied.

Components depicted in FIG. 2 may each refer to software or hardware, such as a field programmable gate array (FPGA) or an application-specific integrated circuit (ASIC). However, the components are not limited to software or hardware and may also be configured to reside in addressable storage media or to execute one or more processors. The functions provided within the components may be implemented by more detailed components, or multiple components may be combined to form a single component that performs specific functions.

A user terminal 300 illustrated in FIG. 2 may include a notebook, desktop, laptop, smartphone, or tablet, but is not limited thereto. The user terminal 300 include any type of device equipped with computing functions.

In some embodiments, the design deliverable generation system 100 illustrated in FIG. 2 may communicate with other components through a network. The network may be implemented as any type of wired or wireless network, such as a local area network (LAN), wide area network (WAN), mobile radio communication network, or Wireless Broadband Internet (WiBro).

The design deliverable generation system 100 and the user terminal 300 may be understood as being operable according to a server-client model. However, in some embodiments, the design deliverable generation system 100 may be configured as a client stand-alone system without a server. In this case, operations performed by the design deliverable generation system 100 may be understood to be performed on the user terminal 300.

The operations performed by each of the components illustrated in FIG. 2 can perform will hereinafter be described with reference to FIG. 2.

In describing some embodiments of the present disclosure, the term “screen” may refer to a display device provided in the design deliverable generation system 100. However, unless otherwise specified, the display device may be interpreted as being provided in the user terminal 300.

Additionally, in describing some embodiments of the present disclosure, the operation in which the design deliverable generation system 100 transmits specific data to the user terminal 300 and the user terminal 300 displays information regarding the specific data on the screen may be exemplified as the design deliverable generation system 100 displaying the information regarding the specific data on the user terminal 300.

The design deliverable generation system 100 may receive a first prompt from the user terminal 300 and transmit the first prompt to a generative AI system 200.

In some embodiments, the design deliverable generation system 100 may receive an image associated with the first prompt from the generative AI system 200 and display the image associated with the first prompt on the screen.

In some embodiments, the design deliverable generation system 100 may stream and display an image being created by the generative AI system 200 on the screen. In other words, the design deliverable generation system 100 may progressively display the process in which the image is being created by the generative AI system 200.

In some embodiments, the design deliverable generation system 100 may receive an image associated with the first prompt from an external storage 400 and display the image associated with the first prompt on the screen.

In some embodiments, the design deliverable generation system 100 may select an image associated with the first prompt from an internal storage of the design deliverable generation system 100 and display the image associated with the first prompt on the screen.

In some embodiments, the design deliverable generation system 100 may select an image associated with the first prompt from an internal storage of the user terminal 300 and display the image associated with the first prompt on the screen of the user terminal 300.

In some embodiments, the design deliverable generation system 100 may receive the user's selection input for at least one of a plurality of images associated with the first prompt and transmit a first image corresponding to the user's selection input to the generative AI system 200.

In some embodiments, the design deliverable generation system 100 may generate a second prompt by modifying the first prompt using features of the first image corresponding to the user's selection input and transmit the second prompt to the generative AI system 200.

In some embodiments, the design deliverable generation system 100 may receive a second image generated by the generative AI system 200 based on the first image and the first prompt and display the second image on the screen.

In some embodiments, the design deliverable generation system 100 may determine whether the second image complies with deliverable review guide.

In some embodiments, the design deliverable generation system 100 may determine whether the second image complies with security guidelines.

For example, if the second image is determined to contain confidential text that must not be disclosed externally, as specified in the security guidelines, the design deliverable generation system 100 may display an alert on the screen of the user terminal 300.

In another example, the security guidelines may include provisions related to copyright infringement prevention. If the second image is determined to contain elements of copyright infringement, the design deliverable generation system 100 may display an alert on the screen of the user terminal 300.

In some embodiments, the design deliverable generation system 100 may determine whether the second image complies with design guidelines.

For example, if a text component included in the second image is determined as not matching a predefined font specified in the design guidelines, the design deliverable generation system 100 may display an alert on the screen of the user terminal 300.

In some embodiments, the design deliverable generation system 100 may display a code editing interface corresponding to the properties of each component included in the second image on the screen of the user terminal 300.

In this case, the user may edit the properties of each component included in the second image using the code editing interface displayed on the screen of the user terminal 300. Further details regarding this will be provided later.

In some embodiments, the design deliverable generation system 100 may receive a second prompt from the user terminal 300 and display the second prompt on the screen of the user terminal 300.

In some embodiments, the design deliverable generation system 100 may evaluate the specificity of a first phrase included in the second prompt. Further details regarding this will be provided later.

In some embodiments, the design deliverable generation system 100 may display a list of sub-concept data included in the first phrase on the screen of the user terminal 300 if the specificity of the first phrase falls below a threshold.

The list of sub-concept data displayed on the screen of the user terminal 300 may include images and text phrases representing sub-concepts included in the first phrase.

In some embodiments, the design deliverable generation system 100 may modify the second prompt using sub-concept data corresponding to the user's selection input for any one of the sub-concept data included in the list of sub-concept data.

An external storage 400 according to one embodiment of the present disclosure may be a work-related storage associated with the user of the user terminal 300. For example, the external storage 400 may be an internal design asset storage that stores past design deliverables of an organization associated with the user. In this case, the design deliverable generation system 100 may transmit some of the data stored in the external storage 400 to the generative AI system 200, and the generative AI system 200 may generate design deliverables corresponding to the prompt received from the design deliverable generation system 100 based on the received data.

In another example, the external storage 400 may be an in-house manual storage that stores security guideline information of an organization associated with the user. In this case, the design deliverable generation system 100 may transmit some of the data stored in the external storage 400 to the generative AI system 200, and the generative AI system 200 may generate design deliverables corresponding to the prompt received from the design deliverable generation system 100 without including components that violate the security guidelines.

Thus far, the components included in the exemplary environment in which the design deliverable generation system 100 may be applied and the operations that can be performed by each of the components have been described with reference to FIG. 2. The aforementioned embodiments are illustrative in all aspects and should not be understood as limiting. Additionally, the configuration and operations of the design deliverable generation system 100 may be supplemented by some of the embodiments that will be described later.

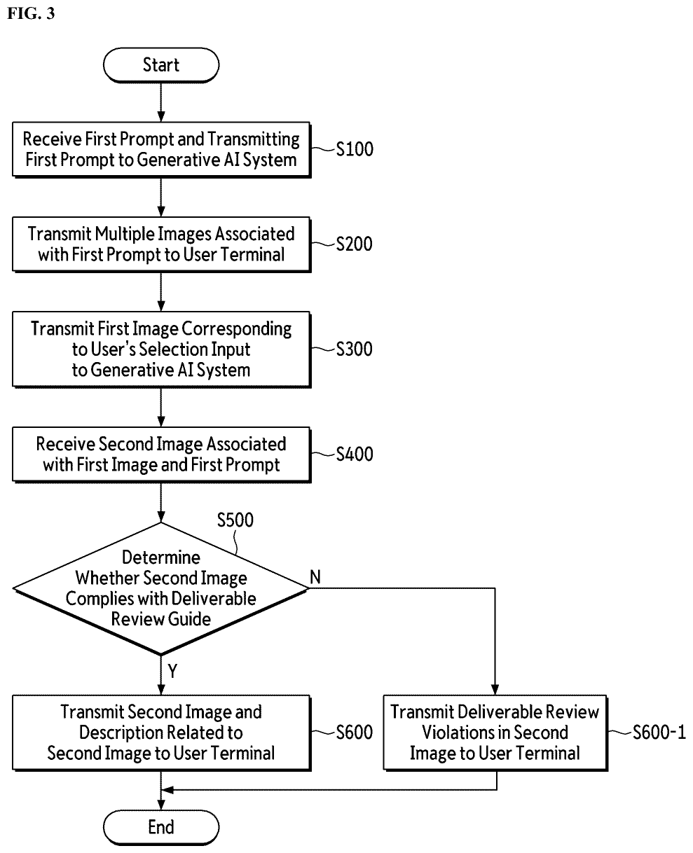

Hereinafter, a method for automatically generating design deliverables according to some embodiments of the present disclosure will be described with reference to FIGS. 3 through 10. The steps to be described in the following flowcharts may be understood as being performed by the design deliverable generation system 100 described with reference to FIG. 2, unless otherwise specified. Additionally, it should be noted that the technical concepts understood from the embodiments described with reference to FIG. 2 are directly applicable to the method for automatically generating design deliverables according to some embodiments of the present disclosure.

For better understanding of some embodiments of the present disclosure, the operation in which the design deliverable generation system 100 receives specific data input by the user on the user terminal 300 from the user terminal 300 may be exemplified as the design deliverable generation system 100 receiving the user's input.

Referring to FIG. 3, in step S100, the design deliverable generation system 100 may receive a first prompt from the user terminal 300 and transmit the first prompt to the generative AI system 200.

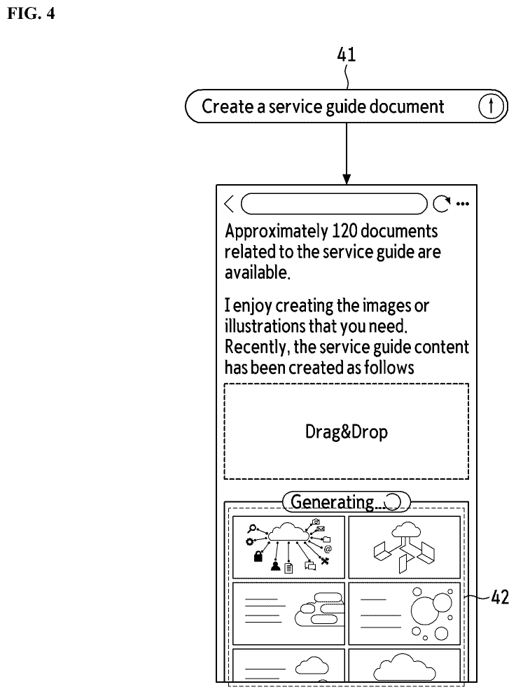

In some embodiments related to step S100, referring to FIG. 4, the design deliverable generation system 100 may receive a first prompt 41, input through an interface displayed on the screen of the user terminal 300, from the user terminal 300.

In step S200, the design deliverable generation system 100 may display a plurality of images associated with the first prompt transmitted by the generative AI system 200 on the screen.

In some embodiments related to step S200, referring to FIG. 4, the design deliverable generation system 100 may receive, as a result of transmitting the first prompt 41, an image set 42 associated with the first prompt 41, generated and transmitted by the generative AI system 200, from the generative AI system 200.

In some embodiments related to step S200, referring to FIG. 4, the design deliverable generation system 100 may receive, as a result of transmitting the first prompt 41, an image set 42 associated with the first prompt 41, selected and transmitted by the external storage 400, from the external storage 400.

In some embodiments related to step S200, referring to FIG. 4, the design deliverable generation system 100 may receive the first prompt 41 from the user terminal 300, transmit a request to search for images associated with the first prompt 41 to the user terminal 300, and receive an image set 42 associated with the first prompt 41 from the user terminal 300.

In some embodiments related to step S200, the image set 42 associated with the first prompt 41 may be an image set where pluralities of images respectively received from the generative AI system 200, the external storage 400, and the user terminal 300, as described in the aforementioned embodiments, coexist.

In some embodiments related to step S200, the images associated with the first prompt 41 may include tag information, and may be images selected by the external storage 400 or the user terminal 300 through comparison of the tag information with the first prompt 41.

In some embodiments related to step S200, the images associated with the first prompt 41 may be images whose similarity with the first prompt 41 exceeds a threshold, selected by the external storage 400 or the user terminal through a semantic analysis.

In step S300, the design deliverable generation system 100 may receive a selection input from the user regarding at least one of the images associated with the first prompt and transmit a first image corresponding to the user's selection input to the generative AI system 200.

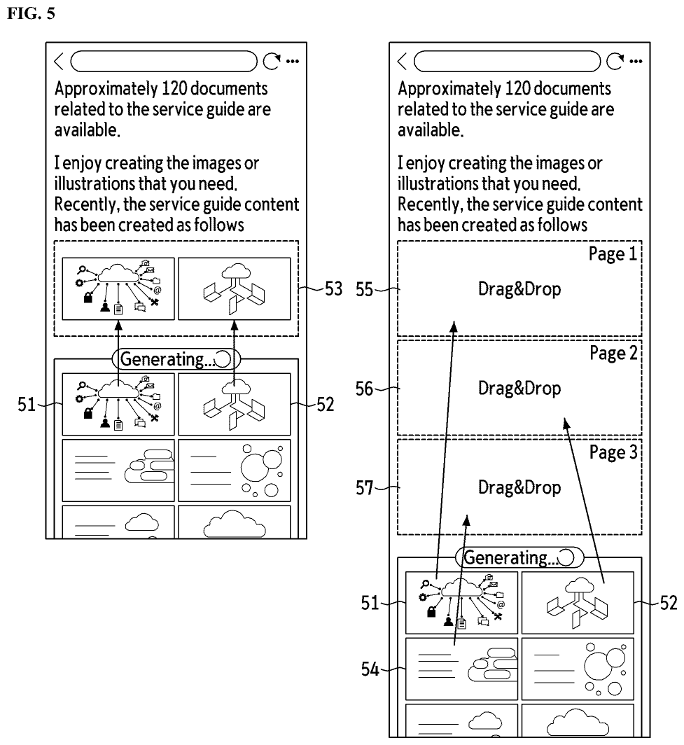

In some embodiments related to step S300, referring to FIGS. 4 and 5, if the user terminal 300 receives, from the user, a selection input for a drag-and-drop operation of a first image 51 and a second image 52 included in the image set 42 associated with the first prompt 41 into a first drop area 53 on the interface displayed on the screen of the user terminal 300, the user terminal 300 may transmit the first and second images 51 and 52 to the design deliverable generation system 100.

In some embodiments related to step S300, referring to FIG. 5, the design deliverable generation system 100 may transmit the first and second images 51 and 52, received from the user terminal 300, to the generative AI system 200.

In some embodiments related to step S300, referring to FIGS. 4 and 5, the design deliverable generation system 100 may receive the image set 42 associated with the first prompt 41 from the generative AI system 200, receive the first and second images 51 and 52 selected by the user from the user terminal 300, and transmit the first and second images 51 and 52 to the generative AI system 200. The design deliverable generation system 100 may then display a newly generated specific image set (not illustrated), created by the generative AI system 200 based on the first and second images 51 and 52, on the screen of the user terminal 300.

Additionally, the design deliverable generation system 100 may receive a selection input from the user regarding any one of the images included in the specific image set displayed on the screen of the user terminal 300, transmit one or more images included in the selected specific image set to the generative AI system 200, and receive a newly generated image based on the transmitted images from the generative AI system 200.

According to the present embodiment, the user may interact with the generative AI until the desired shape of the design deliverable is completed.

In some embodiments related to step S300, referring to FIGS. 4 and 5, if the first prompt 41 input by the user is a prompt for creating an image slide, the design deliverable generation system 100 may have the user terminal 300 display a plurality of second, third, and fourth drop areas 55, 56, and 57. The user terminal 300 may then receive the user's selection input for dragging and dropping the first image 51 into the second drop area 55, the second image 52 into the third drop area 56, and a third image 54 into the fourth drop area 57, and transmit information regarding the images corresponding to the second, third, and fourth drop areas 55, 56, and 57 to the design deliverable generation system 100.

According to the present embodiment, the design deliverable generation system 100 may allow the generative AI system 200 to refer to the properties of the images selected by the user when generating the design deliverable for each specific page of the image slide corresponding to each drop area.

In step S400, the design deliverable generation system 100 may receive, from the generative AI system 200, a second image generated by the generative AI system 200 based on the first image and the first prompt.

In some embodiments related to step S400, referring to FIGS. 4 through 6, the design deliverable generation system 100 may receive, from the generative AI system 200, a fourth image 62 and a fifth image 64 generated by the generative AI system 200 based on the first prompt 41 and the features of the first and second images 51 and 52 selected by the user.

Thereafter, in step S500, the design deliverable generation system 100 may determine whether the second image received from the generative AI system 200 complies with the deliverable review guide.

In some embodiments related to step S500, the design deliverable generation system 100 may determine whether the second image complies with the security guidelines. Further details regarding this will be provided later.

In step S600-1, the design deliverable generation system 100 may display violations of the deliverable review guide in the second image based on a determination that the second image received from the generative AI system 200 does not comply with the deliverable review guide.

In some embodiments related to step S600-1, the violations of the deliverable review guide in the second image may include a case where a specific component of the second image is determined to be similar to a component stored in the external storage 400, which contains security-related information. In other words, the design deliverable generation system 100 may prevent confidential information stored in an internal work-related storage, such as the external storage 400, from being included in design deliverables to be publicly disclosed.

In some embodiments related to step S600-1, the violations of the deliverable review guide in the second image may include a case where the visual component of the second image contains an element that infringes on copyrights. Here, the visual component may refer to a specific object included in the second image, excluding text.

In step S600, if the second image complies with the deliverable review guide, the design deliverable generation system 100 may display the second image along with its related description on the screen.

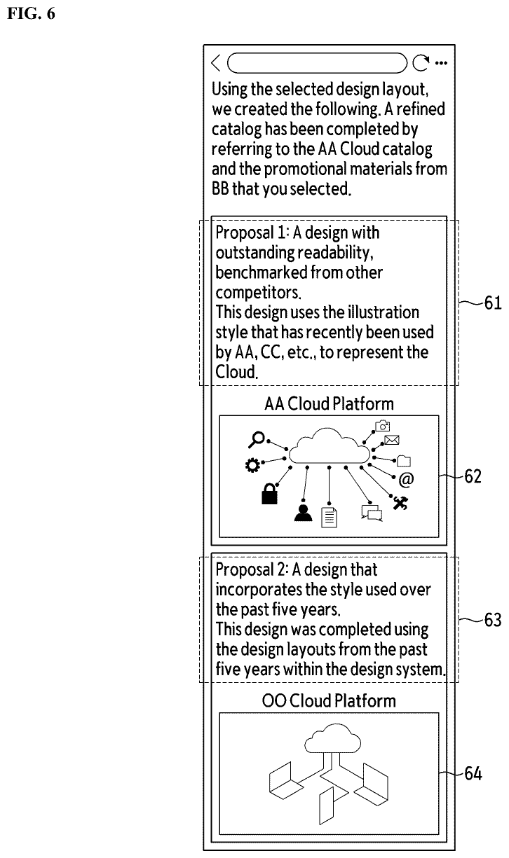

In some embodiments related to step S600, referring to FIG. 6, the design deliverable generation system 100 may receive a first description 61 related to the fourth image 62 and a second description 63 related to the fifth image 64 from the generative AI system 200, and display the first description 61 with the fourth image 62 and the second description 63 with the fifth image 64 on the screen of the user terminal 300.

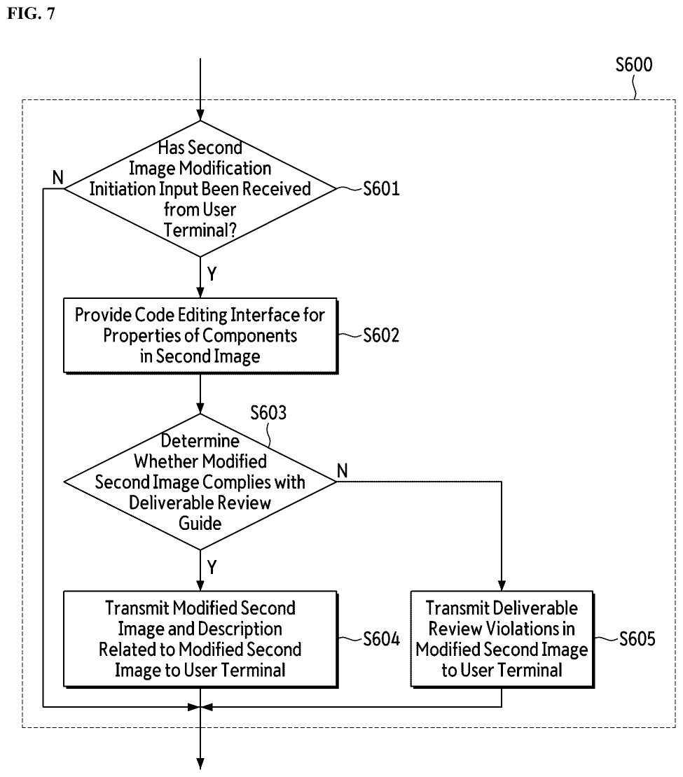

In some embodiments related to step S600, the design deliverable generation system 100 may modify the second image based on the user's input received from the user terminal 300. Further details regarding this will be provided later with reference to FIGS. 7 through 10.

In step S601, the design deliverable generation system 100 may determine whether the user terminal 300 has received modification initiation input for the second image from the user terminal 300.

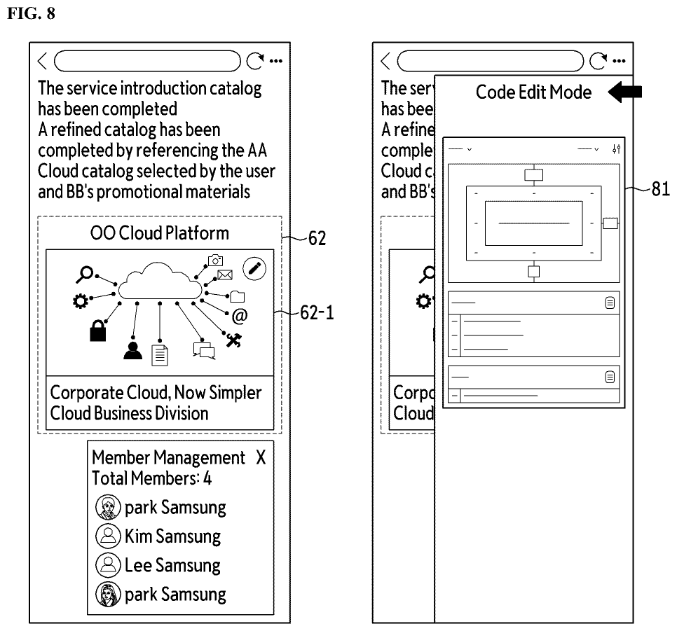

In some embodiments related to step S601, referring to FIG. 8, if the user performs a selection input on a modification initiation input button 62-1 for the fourth image 62 displayed on the screen of the user terminal 300, the design deliverable generation system 100 may determine that the second image is to be modified.

In step S602, if modification initiation input has been received for the second image from the user terminal 300, the design deliverable generation system 100 may provide a code editing interface for each property of each component included in the second image and for each property of the second image.

In some embodiments related to step S602, referring to FIG. 8, if the user's selection input for the modification initiation button 62-1 for the fourth image 62 has been received from the user terminal 300, the design deliverable generation system 100 may send a request to the user terminal 300 to display a code editing interface 81 for the fourth image 62 on the screen.

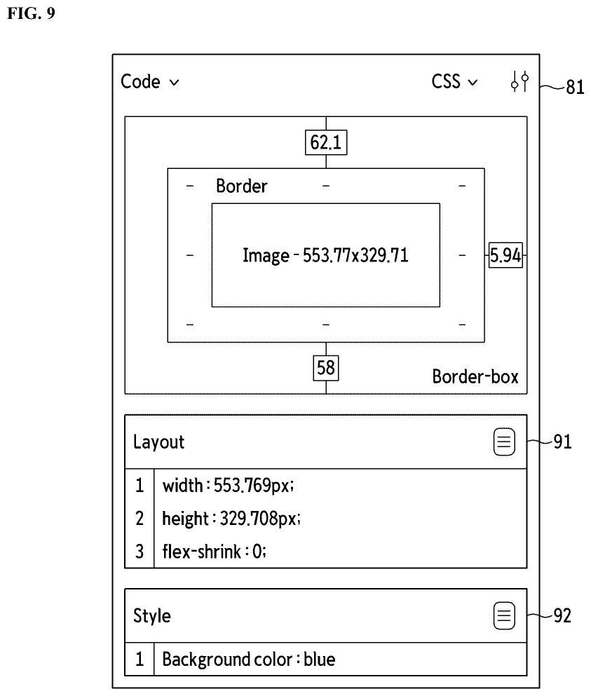

In some embodiments related to step S602, referring to FIG. 9, the code editing interface 81 for the fourth image 62 may include a size editing interface 91 and a background color editing interface 92 for the fourth image 62.

Although only limited examples are illustrated in FIG. 9 for the sake of understanding the present disclosure, the code editing interface 81 for the fourth image 62 may include interfaces for editing the color, size, and shape of any component included in the fourth image 62. Additionally, the code editing interface 81 for the fourth image 62 may include interfaces for editing the color, font, and content of any text included in the fourth image 62.

When both generating an image through communication with the generative AI system 200 and running an image editing tool are performed on a single computing device simultaneously, it may cause excessive waste of computing resources. Therefore, the process of modifying an image provided by the generative AI system 200 must be performed at a code level. According to the present embodiment, the design deliverable generation system 100 may allow even a user without knowledge of computer code to easily perform image modifications at the code level.

In some embodiments related to step S602, the design deliverable generation system 100 may receive user input entered into the code editing interface displayed on the user terminal 300, and modify at least some of the components included in the second image received from the generative AI system 200 based on the user input.

In step S603, the design deliverable generation system 100 may determine whether the modified second image complies with the deliverable review guide. Here, the deliverable review guide may be understood to be the same as that described above with reference to FIG. 3.

In some embodiments related to step S603, the design deliverable generation system 100 may determine whether the modified first component of the second image includes a component that is similar to a component stored in the external storage 400 beyond a threshold, and determine whether the modified second image complies with the deliverable review guide based on the results of the determination.

In some embodiments related to step S603, the design deliverable generation system 100 may determine whether the modified first component of the second image contains an element that infringes on copyrights, and determine whether the modified second image complies with the deliverable review guide based on the results of the determination.

In some embodiments related to step S603, the design deliverable generation system 100 may identify the design guidelines stored in the external storage 400 and determine whether the modified first text component of the second image matches a predefined font specified in the design guidelines, and determine whether the modified second image complies with the deliverable review guide based on the results of the determination.

In some embodiments related to step S603, the design deliverable generation system 100 may identify design guidelines stored in the external storage 400 and determine whether the size of the modified first text component of the second image matches a predefined text size specified in the design guidelines, and determine whether the modified second image complies with the deliverable review guide based on the results of the determination.

In step S604, based on a determination that the modified second image complies with the deliverable review guide, the design deliverable generation system 100 may transmit the modified second image along with its related description to the user terminal 300.

Some embodiments related to step S604 may be clearly understood with reference to step S600, as described above with reference to FIG. 3.

In step S605, based on a determination that the modified second image does not comply with the deliverable review guide, the design deliverable generation system 100 may transmit violations of the deliverable review guide in the modified second image to the user terminal 300.

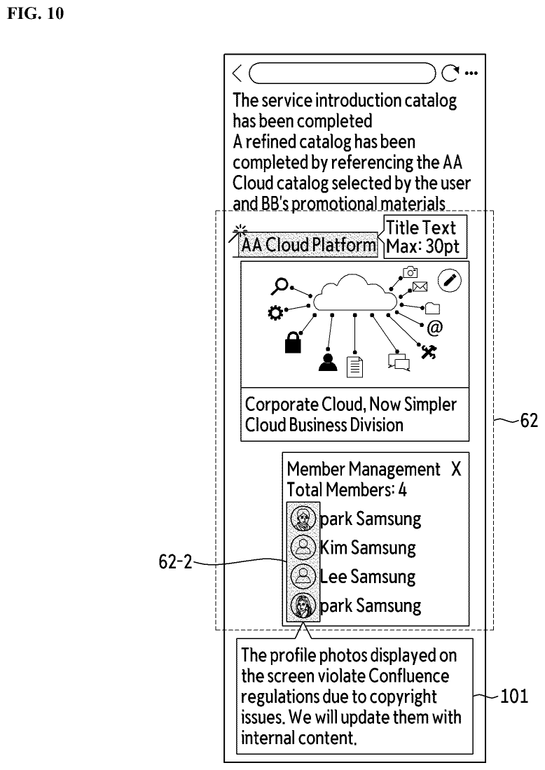

In some embodiments related to step S605, referring to FIG. 10, if a second component 62-2 of the fourth image 62 corresponds to a copyright infringement element, the design deliverable generation system 100 may transmit information regarding the copyright infringement in the fourth image 62 to the user terminal 300, and the user terminal 300 may display an alert 101 regarding the copyright infringement in the fourth image 62 on the screen.

Thus far, a method for automatically generating design deliverables according to some embodiments of the present disclosure has been described with reference to FIGS. 3 through 10. The aforementioned are illustrative in all aspects and should not be understood as limiting.

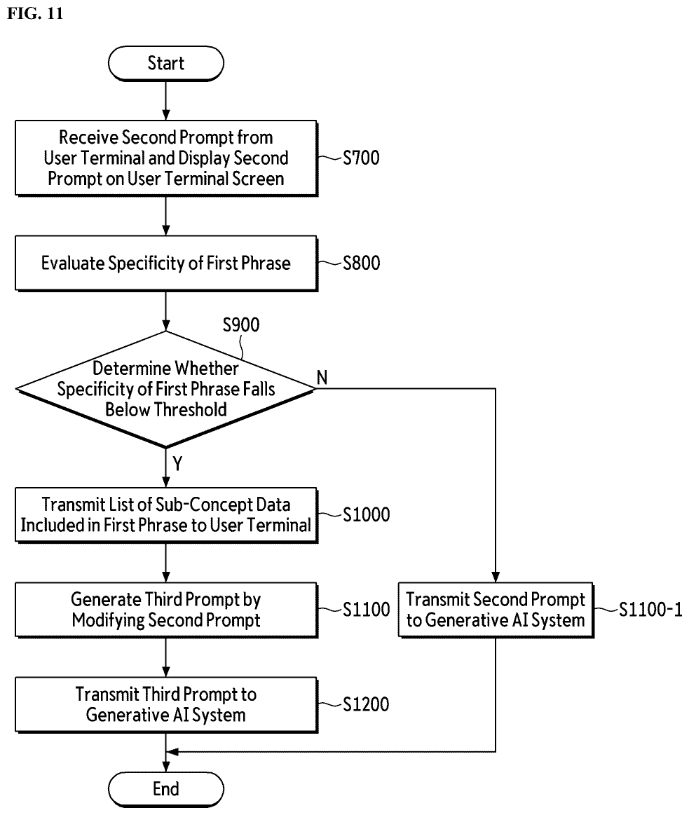

A method for automatically generating design deliverables according to another embodiment of the present disclosure will hereinafter be described with reference to FIGS. 11 through 13. The steps to be described in the following flowcharts may be understood as being performed by the design deliverable generation system 100 described above with reference to FIG. 2, unless otherwise specified. Additionally, it should be noted that the technical concepts understood from the embodiments described above with reference to FIG. 2 are clearly applicable to the embodiments of FIGS. 11 through 13.

In step S700, the design deliverable generation system 100 may receive a second prompt from the user terminal 300.

In some embodiments related to step S700, the user terminal 300 may display the second prompt on the screen. Here, the second prompt may refer to a prompt in the state before it is transmitted from the design deliverable generation system 100 to the generative AI system 200, and the design deliverable generation system 100 may receive the user's prompt input from the prompt input interface displayed on the screen of the user terminal 300 in a streaming manner.

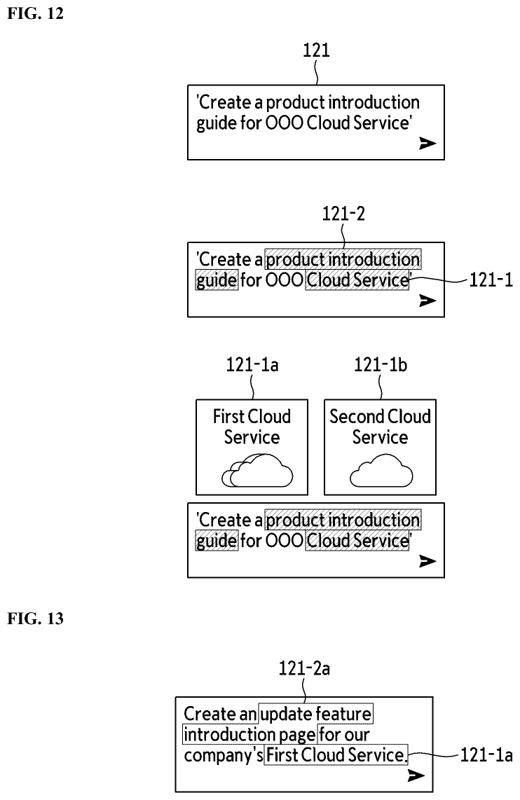

In some embodiments related to step S700, referring to FIG. 12, the design deliverable generation system 100 may receive the second prompt 121, which is the user's input text entered into the prompt input interface displayed on the screen of the user terminal 300, from the user terminal 300 in a real-time streaming manner.

In step S800, the design deliverable generation system 100 may evaluate the specificity of each of a plurality of phrases included in the second prompt.

In step S900, the design deliverable generation system 100 may determine whether the specificity of a first phrase included in the second prompt falls below a threshold.

In some embodiments related to step S900, if the first phrase of the second prompt is a phrase that includes multiple sub-concepts, the design deliverable generation system 100 may determine that the specificity of the first phrase falls below the threshold. Here, the sub-concepts corresponding to the first phrase may refer to the design deliverable generation system 100 determining the presence of information related to the first phrase in the external storage 400 through search from the external storage 400.

In some embodiments related to step S900, referring to FIG. 12, the design deliverable generation system 100 may transmit a first phrase 121-1 of a second prompt 121 to the generative AI system 200 and receive information indicating the presence of first sub-concept data 121-1a and second sub-concept data 121-1b related to the first phrase 121-1 from the generative AI system 200, thereby determining that the specificity of the first phrase 121-1 falls below the threshold.

In some embodiments related to step S900, referring to FIG. 12, the design deliverable generation system 100 may transmit the first phrase 121-1 of the second prompt 121 to the user terminal 300 and receive information indicating the presence of the first and second sub-concept data 121-1a and 121-1b related to the first phrase 121-1 from the user terminal 300, thereby determining that the specificity of the first phrase 121-1 falls below the threshold.

In some embodiments related to step S900, referring to FIG. 12, the design deliverable generation system 100 may transmit the first phrase 121-1 of the second prompt 121 to the external storage 400 and receive information indicating the presence of the first and second sub-concept data 121-1a and 121-1b related to the first phrase 121-1 from the external storage 400, thereby determining that the specificity of the first phrase 121-1 falls below the threshold.

In some embodiments related to step S900, referring to FIG. 12, the design deliverable generation system 100 may perform semantic analysis on the first and second phrases 121-1 and 121-2 of the second prompt 121 and evaluate the specificity of each of the first and second phrases 121-1 and 121-2 based on the results of the semantic analysis.

For example, if the design deliverable generation system 100 performs semantic analysis on the first phrase 121-1 of the second prompt 121 and acquires information indicating that there are multiple types of cloud services (e.g., it is widely known in the technical field that cloud services may include Infrastructure as a Service (IaaS) and Platform as a Service (PaaS)), the design deliverable generation system 100 may determine that the specificity of the first phrase 121-1 falls below the threshold.

In step S1000, the design deliverable generation system 100 may transmit a list of sub-concept data included in the first phrase obtained in step S900 to the user terminal 300.

In some embodiments related to step S1000, the user terminal 300 may display the list of sub-concept data included in the first phrase of the second prompt received from the design deliverable generation system 100 on the screen.

In some embodiments related to step S1000, referring to FIG. 12, the design deliverable generation system 100 may transmit information to the user terminal 300 indicating that the first phrase 121-1 of the second prompt 121 includes first sub-concept data 121-1a and second sub-concept data 121-1b, and the user terminal 300 may display the second prompt 121 along with the first sub-concept data 121-1a and the second sub-concept data 121-1b.

In some embodiments related to step S1000, referring to FIG. 12, the user terminal 300 may receive a selection input from the user regarding the first sub-concept data 121-1a of the first phrase 121-1 and transmit the selection input to the design deliverable generation system 100.

In step S1100, the design deliverable generation system 100 may generate a third prompt by modifying the second prompt based on the sub-concept data selected by the user and transmit the third prompt to the user terminal 300.

In some embodiments related to step S1100, referring to FIGS. 12 and 13, the design deliverable generation system 100 may receive information from the user terminal 300 indicating that the user has selected the first sub-concept data 121-1a from the sub-concept data of the first phrase 121-1 and third sub-concept data 121-2a from the sub-concept data of the second phrase 121-2, generate a third prompt in which the first phrase 121-1 is replaced with the first sub-concept data 121-1a and the second phrase 121-2 is replaced with the third sub-concept data 121-2a, as illustrated in FIG. 13, and transmit the third prompt to the user terminal 300.

In some embodiments related to step S1100, referring to FIG. 13, the user terminal 300 may review the third prompt displayed on the screen and transmit the third prompt to the design deliverable generation system 100 in response to the user's input on a send button.

According to a conventional question-and-answer method using generative AI, the user has difficulty obtaining desired answers unless they enter prompts specifying detailed concepts. However, expecting the user to be able to specify the detailed concepts to inquire about specific knowledge is contradictory. According to the present embodiment, the design deliverable generation system 100 may improve the specificity of the user's prompt, preventing the user from having to perform repeated question-and-answer processes with the generative AI system 200.

In step S1100-1, if each of the phrases included in the second prompt has a specificity above the threshold, the design deliverable generation system 100 may transmit the second prompt to the generative AI system 200.

In step S1200, if the user modifies the second prompt to generate a third prompt and inputs the third prompt to the design deliverable generation system 100 via the user terminal 300, the design deliverable generation system 100 may transmit the third prompt to the generative AI system 200.

In some embodiments related to step S1200, the design deliverable generation system 100 may receive an answer related to the third prompt from the generative AI system 200 and transmit the answer to the user terminal 300. Additionally, the user terminal 300 may display the answer related to the third prompt on the screen.

The method for automatically generating design deliverables according to some embodiments of the present disclosure has been described so far with reference to FIGS. 11 through 13. The aforementioned embodiments are illustrative in all respects and should not be understood as limiting.

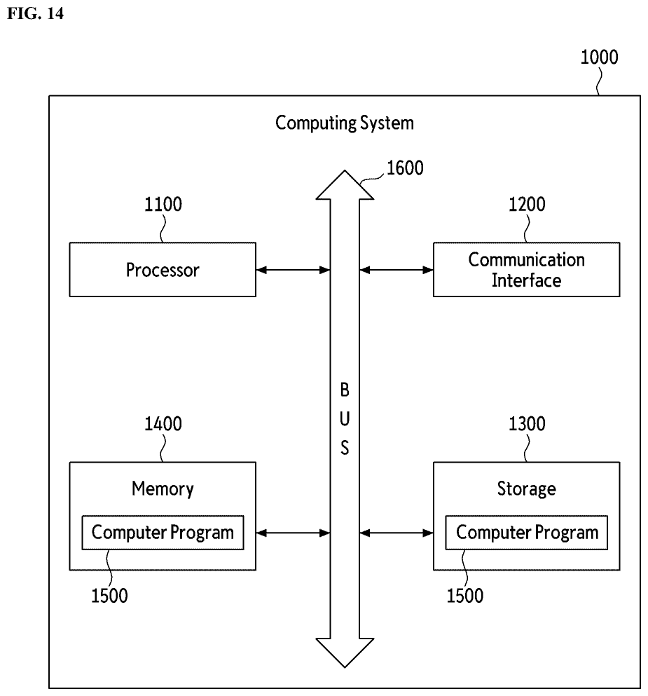

FIG. 14 is a hardware configuration view of an exemplary computing system 1000. The computing system 1000 in FIG. 14 may refer to, the design deliverable system 100 described with reference to FIG. 2. Referring to FIG. 14, the computing system 1000 may include at least one processor 1100, a system bus 1600, a communication interface 1200, a memory 1400, which loads a computer program 1500 executed by the processor 1100, and a storage 1300, which stores the computer program 1500.

The processor 1100 may control the overall operations of the components of the computing system 1000. The processor 1100 may perform computations for at least one application or program for executing operations/methods according to some embodiments of the present disclosure. The memory 1400 may store various data, commands, and/or information. The memory 1400 may load the computer program 1500 from the storage 1300 to execute the operations/methods according to some embodiments of the present disclosure. The memory 1400 may be implemented as a volatile memory such as a random access memory (RAM), but the present disclosure is not limited thereto. The bus 1600 may provide communication functionally among the components of the computing system 1000. The communication interface 1200 may support both wired and wireless Internet communication for the computing system 1000. The storage may temporarily store at least one computer program 1500. The computer program 1500 may include one or more instructions that, upon being loaded into the memory 1400, direct the processor 1100 to perform the operations/methods according to some embodiments of the present disclosure. In other words, by executing the loaded instructions, the processor 1100 may perform the operations/methods according to some embodiments of the present disclosure.

In some embodiments, the computing system 1000 may refer to a virtual machine implemented based on cloud technology. For example, the computing system 1000 may be a virtual machine operating on one or more physical servers within a server farm. In this example, at least some of the components of the computing system 1000, i.e., the processor 1100, the memory 1400, and the storage 1300, may be implemented as virtual hardware, and the communication interface 1200 may be implemented as a virtual networking element such as a virtual switch.

A computer program 1500 according to some embodiments of the present disclosure may include instructions for performing, by a computing system 1000, the operations of: receiving a first prompt from a user terminal; transmitting the first prompt to a generative AI system; transmitting at least some of a plurality of images associated with the first prompt to the user terminal; receiving a user's selection input for at least one of the plurality of images from the user terminal; transmitting a first image corresponding to the user's selection input to the generative AI system; and receiving a second image generated by the generative AI system using the first image and the first prompt.

In some embodiments, the computer program 1500 may include instructions for performing, by the computing system 1000, the operations of: receiving a second prompt from the user terminal; evaluating the specificity of a first phrase included in the second prompt; transmitting a list of sub-concept data included in the first phrase to the user terminal if the specificity of the first phrase falls below a threshold; receiving the user's selection input for first sub-concept data from the list of sub-concept data; and generating a third prompt by modifying the second prompt using the first sub-concept data and transmitting the third prompt to the user terminal.

In some embodiments, the computer program 1500 may include instructions for performing, by the computing system 1000, the operations of: transmitting a first prompt to another computing system; receiving at least some of a plurality of images associated with the first prompt from the other computing system; transmitting the user's selection input for any one of the plurality of images to the other computing system; and receiving an image associated with the selected image from the other computing system.

In some embodiments, the computer program 1500 may include instructions for performing, by the computing system 1000, the operations of: transmitting a second prompt to another computing system; receiving a list of sub-concept data included in a first phrase of the second prompt from the other computing system; transmitting the user's selection input for any one of the sub-concept data from the list of sub-concept data to the other computing system; and receiving a third prompt generated by the other computing system using the selected sub-concept data in response to the user's selection input.

Various embodiments of the present disclosure and their effects have been described with reference to FIGS. 1 to 10. However, the technical concepts of the present disclosure are not limited to the effects set forth herein, and other effects not explicitly mentioned may be readily understood by those skilled in the art to which the present disclosure, from the provided description below.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A design deliverable generation system comprising:
at least one processor;
an internal storage configured to store at least one image; and
a memory configured to store a computer program executed by the at least one processor,
wherein the computer program includes instructions for performing operations of: receiving a first prompt from a user terminal and transmitting the first prompt to a generative artificial intelligence (AI) system; transmitting at least some of a plurality of images associated with the first prompt to the user terminal; receiving a user's selection input for at least one of the plurality of images associated with the first prompt from the user terminal and transmitting a first image corresponding to the user's selection input to the generative AI system; and receiving a second image generated by the generative AI system based on the first image and the first prompt.

2. The design deliverable generation system of claim 1, wherein the plurality of images associated with the first prompt include: images generated by the generative AI system based on the first prompt, images pre-stored in an external storage associated with the first prompt, or images pre-stored in the internal storage associated with the first prompt.

3. The design deliverable generation system of claim 1, wherein
the computer program further includes instructions for performing the operation of transmitting the second image to the user terminal, and
the operation of transmitting the second image to the user terminal comprises transmitting the second image and a description associated with the second image to the user terminal.

4. The design deliverable generation system of claim 1, wherein
the computer program further includes instructions for performing the operation of determining whether the second image complies with a deliverable review guide, and
the operation of determining whether the second image complies with the deliverable review guide comprises: determining whether the second image complies with security guidelines; and determining whether the second image complies with design guidelines.

5. The design deliverable generation system of claim 4, wherein the operation of determining whether the second image complies with the security guidelines comprises: determining whether the second image includes a component having a similarity exceeding a threshold with a component included in data of the security guidelines; and determining whether a visual component of the second image includes an element that infringes on copyrights.

6. The design deliverable generation system of claim 4, wherein the operation of determining whether the second image complies with the design guidelines comprises determining whether a text component of the second image complies with predefined specifications of the design guidelines.

7. The design deliverable generation system of claim 4, wherein the computer program further includes instructions for performing the operation of determining whether when modified, a first property of a first component included in the second image complies with the deliverable review guide.

8. The design deliverable generation system of claim 1, wherein the computer program further includes instructions for performing the operation of providing a code editing interface corresponding to properties of each component included in the second image to the user terminal.

9. A design deliverable generation system comprising:
at least one processor; and
a memory configured to store a computer program executed by the at least one processor,
wherein the computer program includes instructions for performing operations of: receiving a second prompt from a user terminal; evaluating a specificity of a first phrase included in the second prompt; transmitting a list of sub-concept data included in the first phrase to the user terminal if the specificity of the first phrase falls below a threshold; receiving a user's selection input for first sub-concept data from the list of sub-concept data from the user terminal; and transmitting a third prompt obtained by modifying the second prompt using the first sub-concept data, and transmitting the third prompt to the user terminal.

10. The design deliverable generation system of claim 9, wherein the operation of evaluating the specificity of the first phrase included in the second prompt comprises: performing semantic analysis on the second prompt; and determining that the specificity of the first phrase falls below the threshold if the semantic analysis indicates that a plurality of pieces of data corresponding to the first phrase exist.

11. The design deliverable generation system of claim 9, wherein the sub-concept data included in the first phrase includes a first image corresponding to the first phrase, and a second phrase corresponding to the first phrase.

12. The design deliverable generation system of claim 9, wherein the computer program further comprises instructions for performing operations of: transmitting the third prompt to a generative artificial intelligence (AI) system; transmitting at least some of a plurality of images associated with the third prompt to the user terminal; receiving the user's selection input for at least one of the plurality of images associated with the third prompt from the user terminal and transmitting a third image corresponding to the user's selection input to the generative AI system; and receiving a fourth image associated with the third image and the third prompt from the generative AI system.

13. The design deliverable generation system of claim 12, wherein the computer program further comprises instructions for performing the operation of: providing a code editing interface corresponding to properties of each component included in the fourth image to the user terminal.

14. A method for automatically generating design deliverables, performed by a computing system, the method comprising:
receiving a first prompt from a user terminal and transmitting the first prompt to a generative artificial intelligence (AI) system;
transmitting at least some of a plurality of images associated with the first prompt to the user terminal;
receiving a user's selection input for at least one of the plurality of images associated with the first prompt from the user terminal and transmitting a first image corresponding to the user's selection input to the generative AI system; and
receiving a second image generated by the generative AI system based on the first image and the first prompt.

15. The method of claim 14, wherein the plurality of images associated with the first prompt include images generated by the generative AI system based on the first prompt, images pre-stored in an external storage associated with the first prompt, or images pre-stored in an internal storage of the computing system associated with the first prompt.

16. The method of claim 14, further comprising:
transmitting the second image to the user terminal,
wherein the transmitting the second image comprises transmitting the second image and a description associated with the second image to the user terminal.

17. The method of claim 14, further comprising:
determining whether the second image complies with a deliverable review guide,
wherein the determining whether the second image complies with the deliverable review guide comprises: determining whether the second image complies with security guidelines; and determining whether the second image complies with design guidelines.

18. The method of claim 17, wherein the determining whether the second image complies with the security guidelines comprises: determining whether the second image includes a component having a similarity exceeding a threshold with a component included in the security guidelines; and determining whether a visual component of the second image includes an element that infringes on copyrights.

19. The method of claim 17, wherein the determining whether the second image complies with the design guidelines comprises determining whether a text component of the second image complies with predefined specifications of the design guidelines.

20. The method of claim 14, further comprising:
receiving a second prompt from the user terminal and displaying the second prompt on a screen of the user terminal;
evaluating a specificity of a first phrase included in the second prompt;
transmitting a list of sub-concept data included in the first phrase to the user terminal if the specificity of the first phrase falls below a threshold;
receiving a user's selection input for first sub-concept data from the list of sub-concept data from the user terminal; and
generating a third prompt by modifying the second prompt using the first sub-concept data and transmitting the third prompt to the user terminal.
